(19) United States
(12) Patent Application Publication
(10) Pub. No.: US 2026/0366490 A1
(43) Pub. Date: Nov. 19, 2026

(54) Adjustable Ballast-Buoyant Stabilizer System to Reduce the Length of the Spar Floater Structure of Floating Wind Turbine Towers to Allow for the Operation of these Shortened Structures in Depths not Suitable for Full-Length Spar-Type Floating Wind Turbine Towers and for Viable Sea Transportation as an Emergency-Driven Portable Electric Generating System.

(71) Applicant: Joseph Carlo Pastrana, Sneads Ferry, NC (US)

(72) Inventor: Joseph Carlo Pastrana, Sneads Ferry, NC (US)

(73) Assignee: Joseph Carlo Pastrana, Sneads Ferry, NC (US)

(21) Appl. No.: 19/672,622

(22) Filed: May 9, 2026

(51) Int. Cl. F03D 13/25; B63B 35/44; B63B 39/03; F03D 13/20

(52) U.S. Cl. CPC F03D 13/256; B63B 35/44; B63B 39/03; F03D 13/201; B63B 2035/446; F05B 2240/93

(57) ABSTRACT

An Adjustable Ballast-Buoyant Stabilizer System for the purpose of reducing the length of the Spar Floater structure of Floating Wind Turbine Towers to allow for the operation of these shortened structures in water depths not suitable for Full-Length Spar-Type Floating Wind Turbine Towers and for viable Sea Transportation. The Adjustable Ballast-Buoyant Stabilizer System comprises of Ballast-Buoyant Stabilizers integrated into Ballast-Buoyant Structures capable of changing their angles and vertically moving up and down along the length of the Spar Floater structure of Floating Wind Turbine Towers to manipulate hydrodynamic forces. To allow a Ballast-Buoyant Structure to change angles, a Spherical Bearing system integrated in the Ballast-Buoyant Structure, and managed by Artificial Intelligence, provides the required angular movements necessary to manipulate hydrodynamic forces and maintain the vertical alignment required by shortened Floating Wind Turbine Towers.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### COMPACT DISK APPENDIX

Not applicable to this application

### STATEMENT REGARDING PRIOR DISCLOSURES BY THE INVENTOR

Not applicable to this application

### BACKGROUND OF THE INVENTION

The offshore Floating Wind Turbine Towers technology presents a significant opportunity to unlock vast renewable energy potential in deep water regions, potentially contributing to clean energy generation capacity and accelerating global clean energy goals. While current projects showcase the technology's potential, limitations require attention for broader adoption.

Current wind turbine tower installations are vulnerable to harsh weather and remote locations, especially for ever-growing wind turbine sizes. Innovation in installation and maintenance methods is crucial for overcoming these limitations. Accordingly, optimizing floating wind turbine towers designs for diverse regional and environmental conditions, expanding and innovating installation capabilities and developing breakthrough installation methods are critical for the successful and efficient deployment of these structures and remain highly desirable.

### DESCRIPTION OF PRIOR ART

Not applicable to this application

### BRIEF SUMMARY OF THE INVENTION

The invention is an Adjustable Ballast-Buoyant Stabilizer System for the purpose of reducing the length of the Spar Floater structure of Floating Wind Turbine Towers to allow for the operation of these shortened structures in water depths not suitable for Full-Length Spar-Type Floating Wind Turbine Towers and for viable Sea Transportation. The Adjustable Ballast-Buoyant Stabilizer System (ABBSS) comprises of Adjustable Ballast-Buoyant Stabilizers (ABB Stabilizers) integrated into Adjustable Ballast-Buoyant Structures (ABB Structures) capable of changing their angles and vertically moving up and down along the length of the Spar Floater structure of Floating Wind Turbine Towers to manipulate hydrodynamic forces. To allow a Ballast-Buoyant Structure to change angles, a Spherical Bearing System integrated in the Ballast-Buoyant Structure, and managed by Artificial Intelligence, provides the required angular movements necessary to manipulate hydrodynamic forces and maintain the vertical alignment required by shortened Floating Wind Turbine Towers.

### BRIEF DESCRIPTION OF THE SEVERAL VIEWS OF THE DRAWINGS

The drawings are illustrated as examples of the invention's functionality and are not intended to limit the invention. The invention is capable of considerable modification, alteration and equivalents in form and function, accordingly:

FIG. 1 depicts a Floating Wind Turbine Spar-Type Tower utilizing the invention, the Adjustable Ballast-Buoyant Stabilizer System (ABBSS) incorporated into a Floating Wind Turbine Tower with a Shortened Spar Floater Structure designed for Shallow Waters and feasible Sea Transportation.

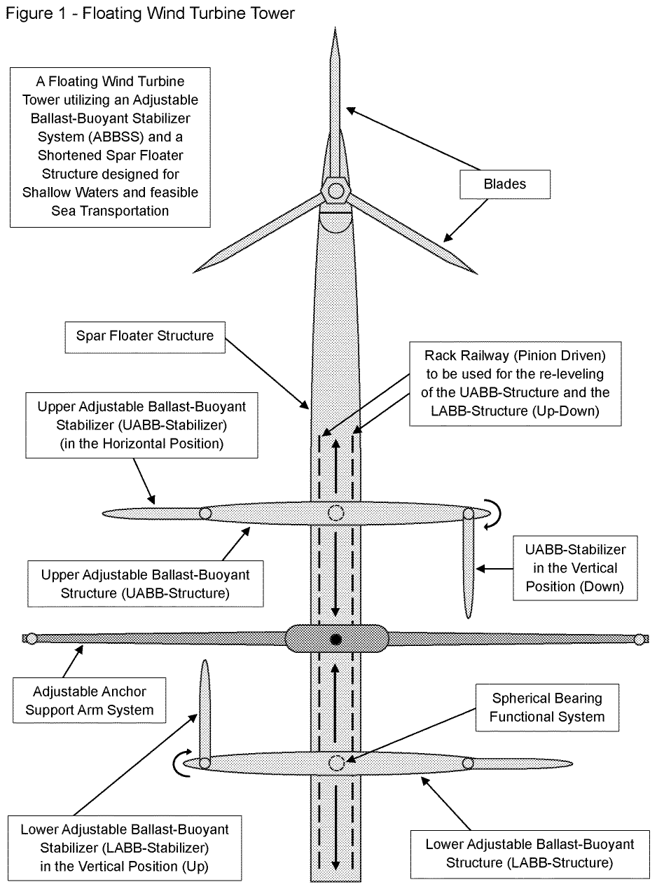

FIG. 2 depicts the Adjustable Ballast-Buoyant Stabilizer System (ABBSS) with an Upper Adjustable Ballast-Buoyant Structure (UABB Structure) turned to a 30° angle, a Lower Adjustable Ballast-Buoyant Structure (LABB Structure) turned to a 20° angle, the Upper Mooring Line connected to the Adjustable Anchor Support Arm Systems, and the Lower Mooring Line, wherein the UABB Structure and the LABB Structure comprise the Adjustable Ballast-Buoyant Structures (ABB Structures).

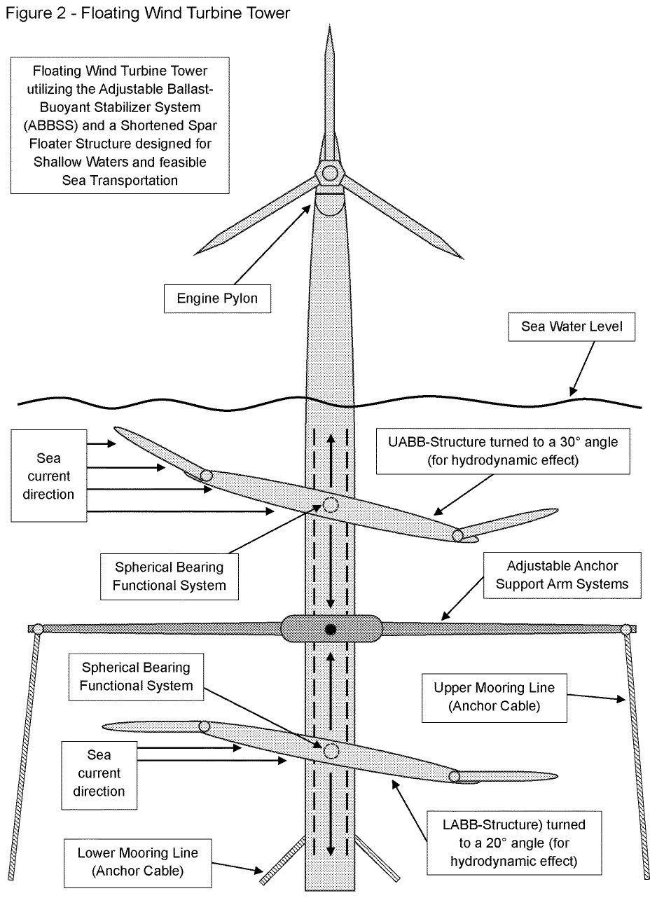

FIG. 3 depicts the Upper Adjustable Ballast-Buoyant Structure (UABB Structure) with 8 Upper Adjustable Ballast-Buoyant Stabilizers (UABB Stabilizers).

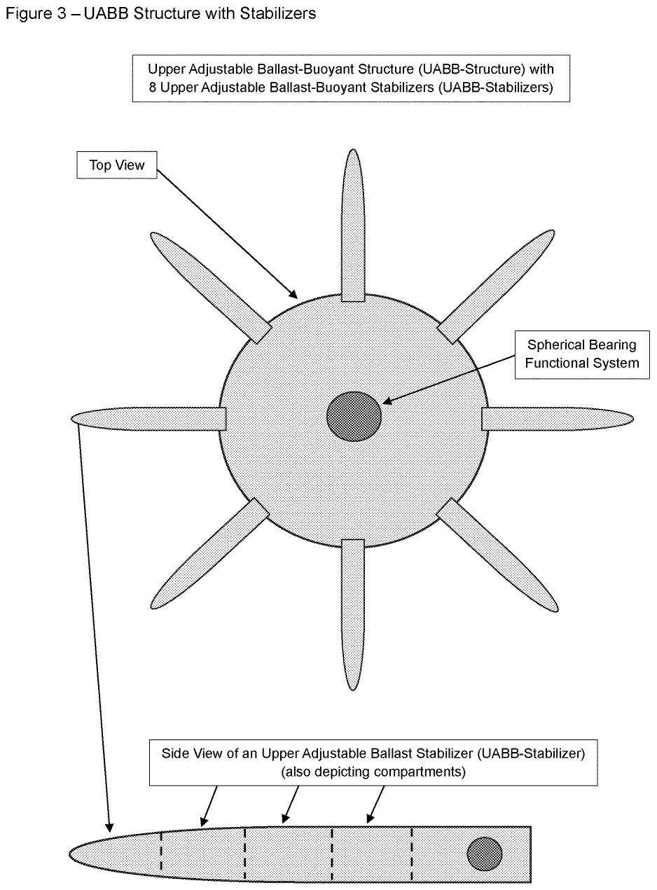

FIG. 4 depicts the side view of the Upper Adjustable Ballast-Buoyant Structure (UABB Structure) without the Adjustable Ballast-Buoyant Stabilizers.

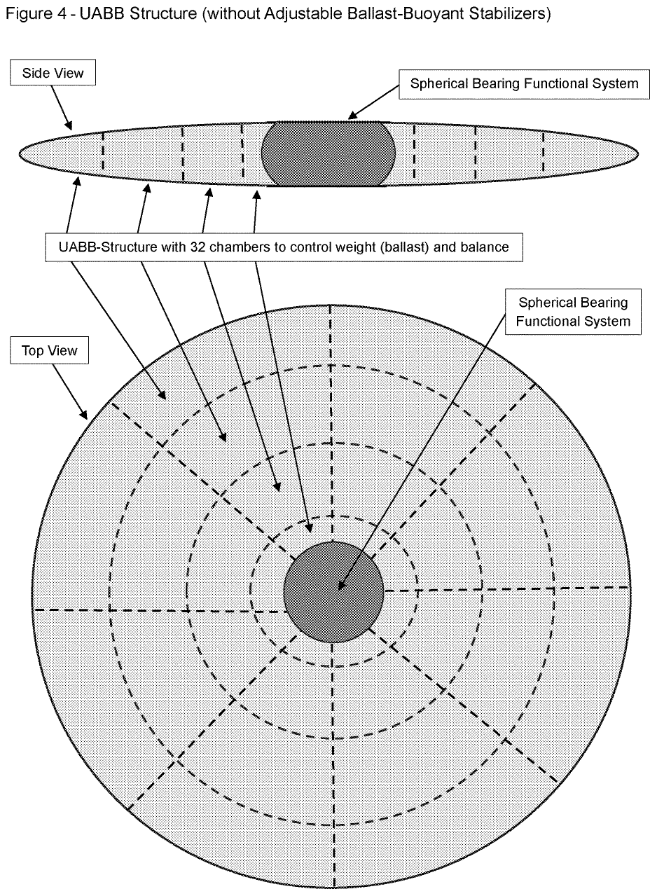

FIG. 5 depicts the Upper Adjustable Ballast-Buoyant Structure (UABB Structure) with one section extended to add stability control and prevent excessive tower listing (inclination) of the Floating Wind Turbine Tower via the control of hydrodynamic forces, wherein the Upper Adjustable Ballast-Buoyant Structure (UABB Structure) and the Lower Adjustable Ballast-Buoyant Structure (LABB Structure) are divided by sections, and each section is capable to extended away from the center of the said UABB and LABB structures, and wherein each section extent away from the center of the UABB and LABB structures via electro-hydraulic actuators, gears, fasteners, electric motors, and a rack railway system.

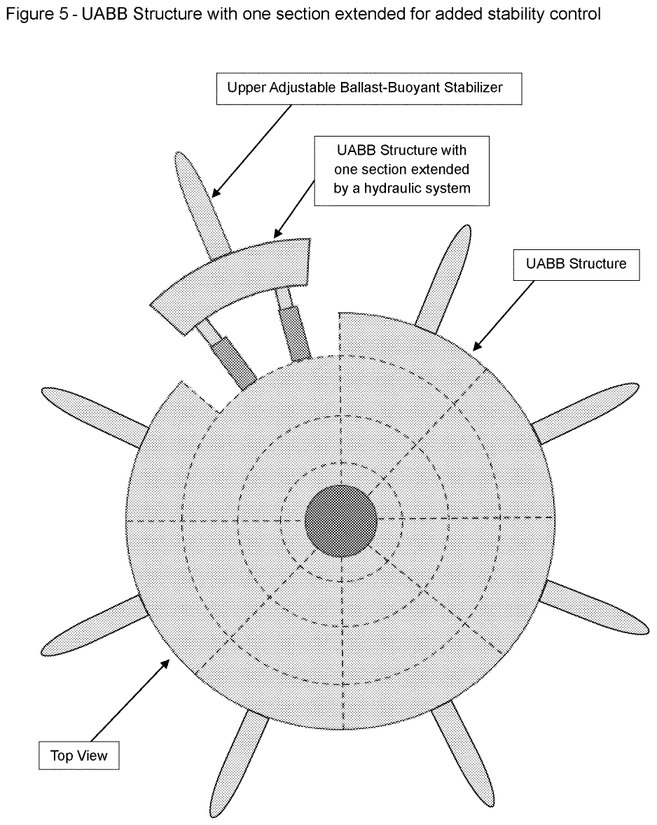

FIG. 6 depicts the Lower Adjustable Ballast-Buoyant Structure (LABB Structure) with 4 Lower Adjustable Ballast-Buoyant Stabilizers (LABB Stabilizers) and 4 Telescopic Collapsible Landing Legs. The Telescopic Collapsible Landing Legs (TCLL) is comprised of Electro-Hydraulic Actuators (EHAs) to change the operating angles and length of the said Telescopic Collapsible Landing Legs via AI electronic commands and wherein the said Telescopic Collapsible Landing Legs function as shock absorbers to prevent excessive tower listing (inclination) and maintain vertical control (alignment) of the floating wind turbine tower by ensuring continuous leg contact with seafloor and wherein the said Telescopic Collapsible Landing Legs are not for the lifting of Floating Wind Turbine Towers from the seafloor.

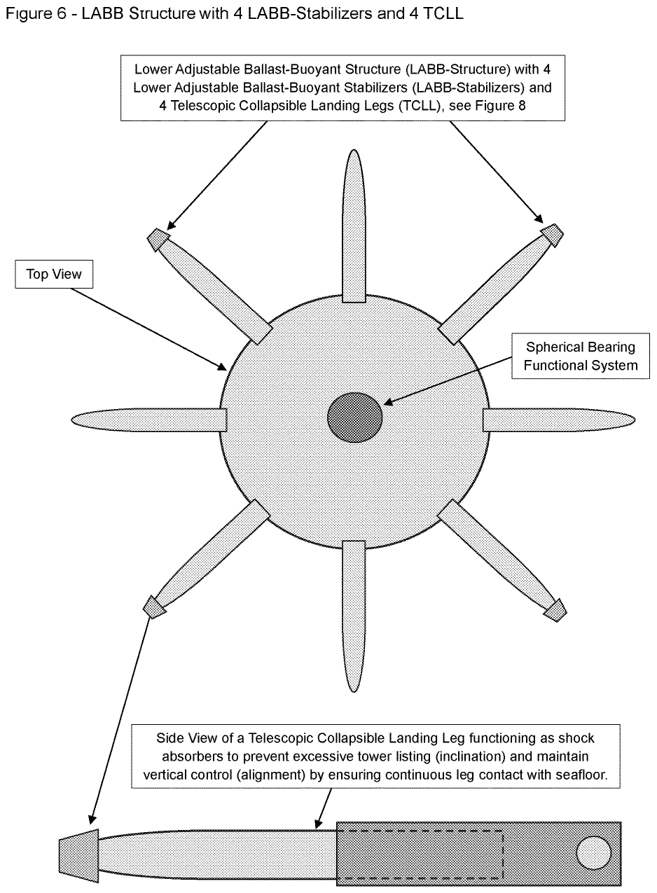

FIG. 7 depicts the Adjustable Anchor Support Arm System to prevent excessive tower listing (inclination) and maintain vertical control (alignment) of the Floating Wind Turbine Tower by ensuring continuous control of the tower structure center of gravity.

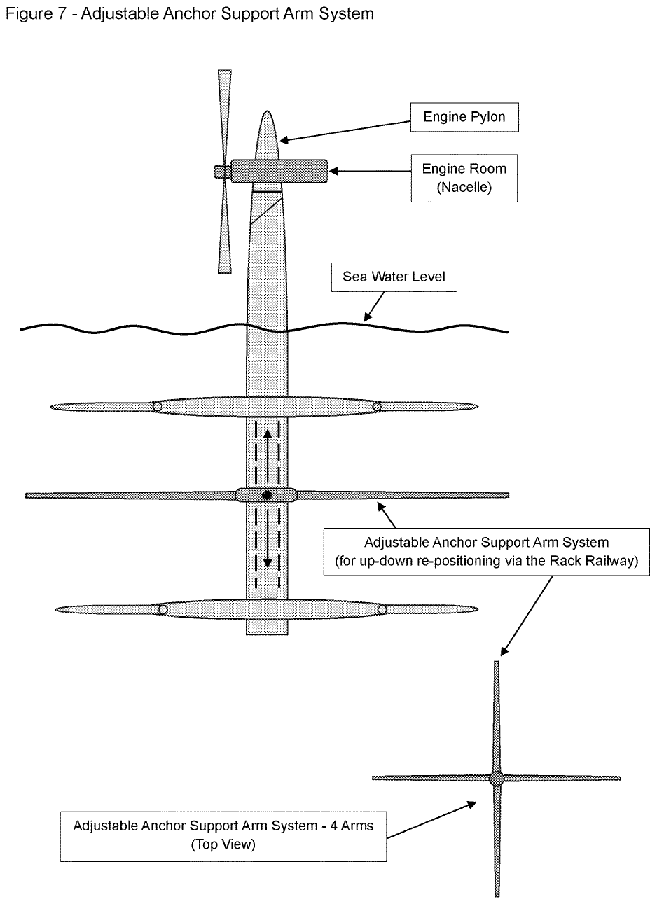

FIG. 8 depicts the Lower Adjustable Ballast-Buoyant Structure (LABB Structure) utilizing four Telescopic Collapsible Landing Legs to assist in the stability of the Wind Turbine.

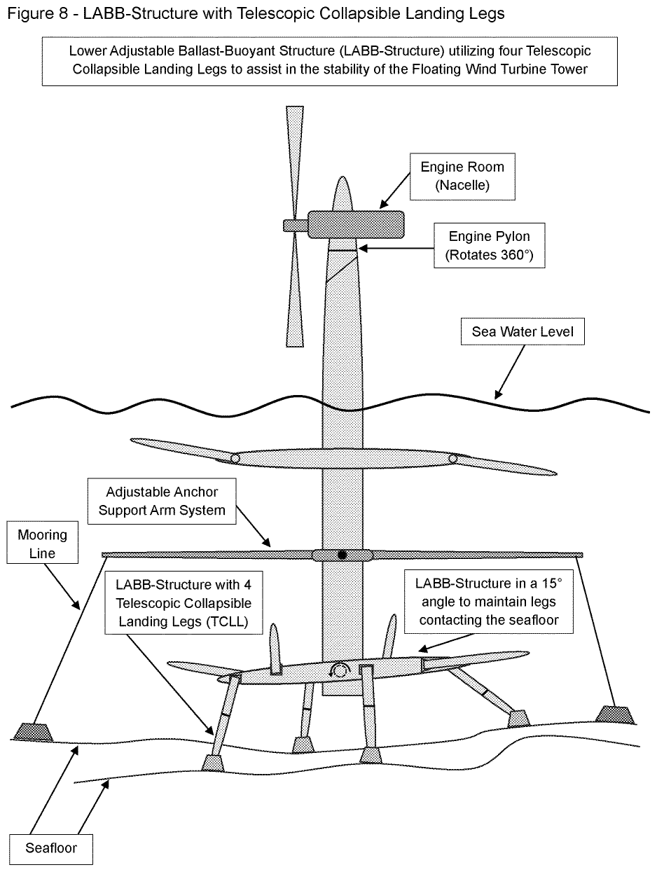

FIG. 9 depicts a Spar Tower and a shortened Spar Tower design with the Adjustable Ballast-Buoyant Stabilizer System for Floating Wind Turbine Towers designed for Shallow Waters and faster Sea Transportation.

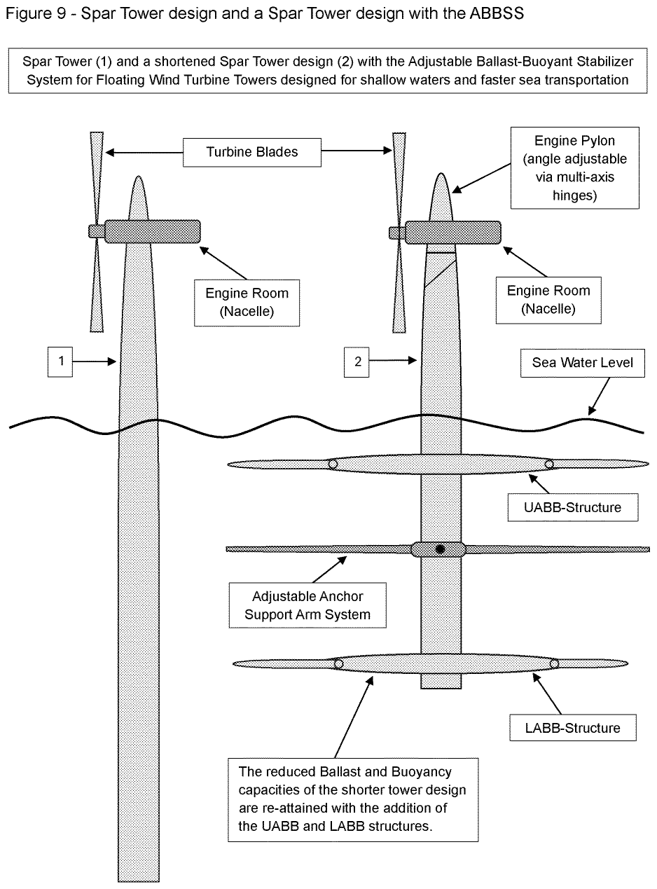

FIG. 10 depicts a Floating Wind Turbine Tower Spar on the water (floating) ready for sea transportation via Tugboats with the Engine Pylon in a Vertical Position.

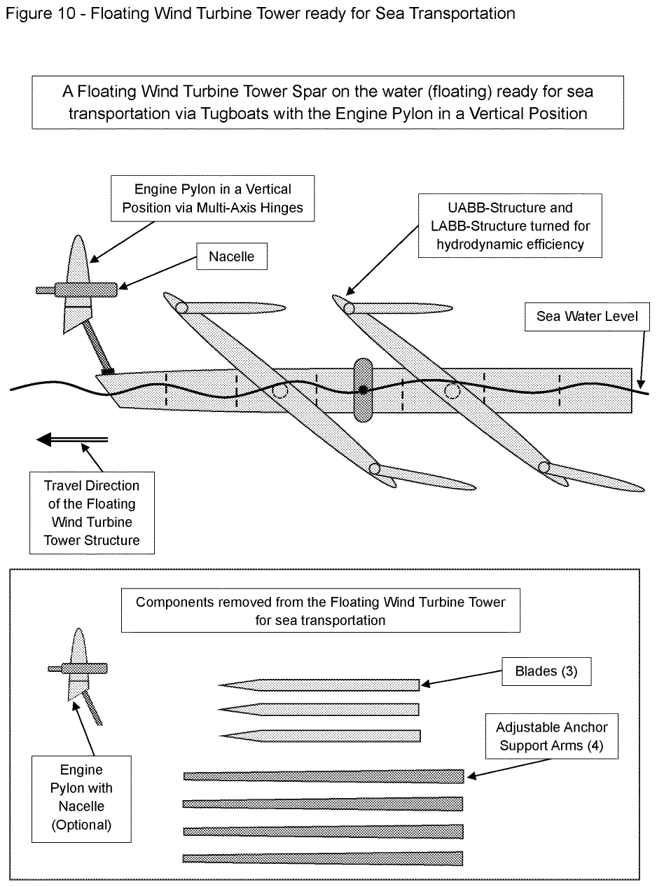

FIG. 11 depicts the Floating Wind Turbine Tower Vertical to Horizontal Auto Positioning System process.

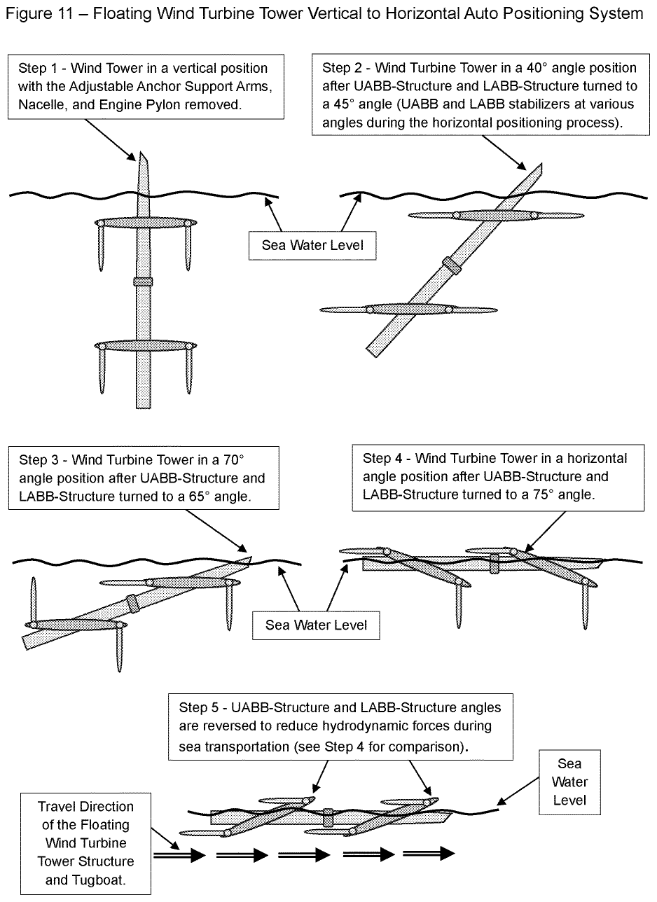

### DETAILED DESCRIPTION OF THE INVENTION

The invention consists of an Adjustable Ballast-Buoyant Stabilizer System (ABBSS) controlled by Artificial Intelligence for the purpose of reducing the length of spar floater section of floating wind turbine spar-type towers to allow for the operation of shortened floating wind turbine spar-type towers in water depths not suitable for full-length spar-type floating wind turbine towers and to minimize the listing (inclination) and maintain the vertical control (alignment) and of Floating Wind Turbine Towers. The Adjustable Ballast-Buoyant Stabilizer System (ABBSS) comprises of Adjustable Ballast-Buoyant Stabilizers (ABB Stabilizers) integrated into Adjustable Ballast-Buoyant Structures (ABB Structures) capable of changing their angles and vertically moving up and down along the length of the Spar Floater structure of Floating Wind Turbine Towers to manipulate hydrodynamic forces. To allow the Ballast-Buoyant Structures to change their angles, a Spherical Bearing System integrated into the Ballast-Buoyant Structure, managed by Artificial Intelligence, provides the required angular movements necessary to manipulate hydrodynamic forces and maintain the vertical alignment required by shortened Floating Wind Turbine Towers. The Adjustable Ballast-Buoyant Structures (ABB Structures) are controlled via Electro-Hydraulic Actuators (EHAs) to acquire the angle positioning required to avoid the listing (inclination) and maintain the vertical control (alignment) and of the said Floating Wind Turbine Towers.

A software program and a computer system with a dedicated Neural Processing Unit (NPU) designed to run AI is utilized to process electronic input data and to run the required software instructions to perform the required operations of the said ballast-buoyant structures.

The said computer system operates a Gyroscope System driven by a Micro-Electro-Mechanical System (MEMS) to adjust the angle of the Ballast-Buoyant Structures via Electro-Hydraulic Actuators (EHAs) based on the Floating Wind Turbine Spar Type Tower listing's angle value, continuous real-time weather data feed, and the speed and direction of the wind and water motion (current) data obtained by AI from electronic sensors operating on a continuous real-time basis to minimize or eliminate the listing of the said Floating Wind Turbine Spar Type Tower.

The Adjustable Ballast-Buoyant Stabilizers (ABB Stabilizers) and the Adjustable Ballast-Buoyant Structures operate at different ballast and buoyancy configurations via the added or reduced fluid (ballast) or buoyancy by electric fluid pumps, wherein each adjustable variable ballast stabilizer and adjustable variable ballast structure contains multiple compartments and each compartment can be filled independently for the purpose of eliminating or controlling the listing of the shortened floating wind turbine spar type tower.

The said AI computer system operates and controls multiple Adjustable Ballast-Buoyant Stabilizers at different angles via Electro-Hydraulic Actuators for the purpose of minimizing or eliminating the listing of the shortened floating wind turbine spar-type towers.

The said AI computer system operates the Adjustable Ballast-Buoyant Structures at different angles via a Spherical Bearing System and Electro-Hydraulic Actuators for the purpose of eliminating or controlling the listing of the shortened floating wind turbine spar type tower.

The AI computer system operates the Adjustable Ballast-Buoyant Structures at different elevations moving up and down along the spar floater section of floating wind turbine tower structures via a Rack Railway System (Pinion Driven) and electronic motors with gears for the purpose to minimize or eliminate the listing of the shortened floating wind turbine spar type tower.

The Adjustable Ballast-Buoyant Stabilizer System (ABBSS) controlled by Artificial Intelligence is comprised of Electro-Hydraulic Actuators to change the operating angles of the said ABB Stabilizers via AI electronic commands.

The ABBSS' Telescopic Collapsible Landing Legs (TCLL) is comprised of Electro-Hydraulic Actuators to change the operating angles and length of the said Telescopic Collapsible Landing Legs via AI electronic commands and wherein the said Telescopic Collapsible Landing Legs function as shock absorbers to prevent excessive tower listing (inclination) and as hydraulic lifters to assist and maintain vertical control (alignment) of the floating wind turbine tower by ensuring continuous leg contact with seafloor.

The ABBSS' ABB Structures are comprised of Electro-Hydraulic Actuators to change the operating angles of the said ABB Structures via AI electronic commands.

The ABBSS' Spherical Bearing System is comprised of a joint bearing system to handle radial and axial loads and permit a 360° rotation of the Adjustable Ballast-Buoyant Structures (ABBS) around the outside surface of the spar floater structure and wherein the said Spherical Bearing System is operating through electro-hydraulic actuators, electric motors, a Rack Railway System (pinion driven) circulating horizontally around the outside diameter of the spar floater structure, a gear system, and AI computer system to process the required electronic commands for the purpose of executing the required functioning of the electro-mechanical components of the said Spherical Bearing System.

The ABBSS' Rack Railway System (Pinion Driven) is controlled by Artificial Intelligence and is comprised of wheels, gears, fasteners, electric motors, and Electro-Hydraulic Actuators to provide the said Adjustable Ballast-Buoyant Stabilizer System with the capability to support and travel up and down along the length of floating wind turbine spar-type towers.

The ABBSS' Engine Pylon is angle adjustable via multi-axis hinges operated by Electro-Hydraulic Actuators controlled by the said computer system.

The ABBSS' Vertical to Horizontal Auto Positioning System provides a computer-controlled vertical to horizontal positioning process to change the orientation of a Floating Wind Turbine Spar-Type Tower from a vertical position to a horizontal position through angular changes made by the ABB Structures and ABB Stabilizers via Electro-Hydraulic Actuators, and changes in the ballast and buoyancy of the said ABB Structures, ABB Stabilizers, and the Floating Wind Turbine Spar-Type Tower are attained through electric fluid pumps adding or reducing liquid fluid to the said ABB Structures, ABB Stabilizers, and Floating Wind Turbine Spar-Type Tower.

The ABBSS' Adjustable Anchor Support Arm System vertically re-position up-down anchor support arms to control the center of gravity of the said Floating Wind Turbine Spar Type Tower to assist in the vertical control of the said Floating Wind Turbine Spar Type Tower via the Rack Railway System (Pinion Driven) and Electro-Hydraulic Actuators.

I claim:

1. An Adjustable Ballast-Buoyant Stabilizer System (ABBSS) controlled by Artificial Intelligence to reduce the length of spar floater section of floating wind turbine spar-type towers to allow for the operation of shortened floating wind turbine spar-type towers in water depths not suitable for full-length spar-type floating wind turbine towers, comprising of: operating, through a computerized system driven by Artificial Intelligence (AI), Adjustable Ballast-Buoyant Structures (ABB Structures) via Electro-Hydraulic Actuators (EHAs) to acquire the angle positioning required to avoid the listing (inclination) and maintain the vertical control (alignment) and of the said floating wind turbine towers; installing, by the manufacturer, a computer software application and a computer system with a dedicated Neural Processing Unit (NPU) designed to run AI to process electronic input data, the software instructions, and mathematical calculations required to perform the operations of the said ballast-buoyant structures required to maintain the vertical control of the said floating wind turbine towers; operating, by the said AI computer device with a dedicated NPU, the software designed to perform the electronic instructions required to evaluate the electronic data received, generate mathematical calculations, and execute the required functioning of the electro-mechanical components of the said ballast-buoyant structures; operating, by the said AI computer system with a dedicated NPU, a Gyroscope System driven by a Micro-Electro-Mechanical System (MEMS) to adjust the angle of the ballast-buoyant structures via Electro-Hydraulic Actuators (EHAs) based on the Floating Wind Turbine Spar Type Tower listing's angle value, continuous real-time weather data feed, and the speed and direction of the wind and water motion (current) data obtained by AI from electronic sensors operating on a continuous real-time basis to minimize or eliminate the listing of the said Floating Wind Turbine Spar Type Tower; operating, by the said AI computer system with a dedicated NPU, the Adjustable Ballast-Buoyant Stabilizers (ABB Stabilizers) and the Adjustable Ballast-Buoyant Structures at different ballast and buoyancy configurations via the added or reduced weight (ballast) or buoyancy by electric fluid pumps, wherein each adjustable variable ballast stabilizer and adjustable variable ballast structure contains multiple compartments and each compartment can be filled independently for the purpose of eliminating or controlling the listing of the shortened floating wind turbine spar type tower; operating, by the said AI computer system with a dedicated NPU, the Adjustable Ballast-Buoyant Stabilizers at different angles via Electro-Hydraulic Actuators for the purpose to minimize or eliminate the listing of the shortened floating wind turbine spar type tower; operating, by the said AI computer system with a dedicated NPU, the Adjustable Ballast-Buoyant Structures at different angles via a Spherical Bearing System and Electro-Hydraulic Actuators for the purpose of eliminating or controlling the listing of the shortened floating wind turbine spar type tower; operating, by the said AI computer system with a dedicated NPU, the Adjustable Ballast-Buoyant Structures at different elevations moving up and down along the spar floater section of floating wind turbine tower structures via a Rack Railway System (Pinion Driven) and electronic motors with gears for the purpose of minimize or eliminate the listing of the shortened floating wind turbine spar type tower.

2. The Adjustable Ballast-Buoyant Stabilizer System (ABBSS) controlled by Artificial Intelligence of claim 1, wherein the ABBSS' ABB Stabilizers is comprised of Electro-Hydraulic Actuators to change the operating angles of the said ABB Stabilizers via AI electronic commands.

3. The Adjustable Ballast-Buoyant Stabilizer System (ABBSS) controlled by Artificial Intelligence of claim 1, wherein the ABBSS' the Telescopic Collapsible Landing Legs (TCLL) is comprised of Electro-Hydraulic Actuators (EHAs) to change the operating angles and length of the said Telescopic Collapsible Landing Legs via AI electronic commands and wherein the said Telescopic Collapsible Landing Legs function as shock absorbers to prevent excessive tower listing (inclination) and maintain vertical control (alignment) of the floating wind turbine tower by ensuring continuous leg contact with seafloor.

4. The Adjustable Ballast-Buoyant Stabilizer System (ABBSS) controlled by Artificial Intelligence of claim 1, wherein the ABBSS' ABB Structures are comprised of Electro-Hydraulic Actuators to change the operating angles of the said ABB Structures via AI electronic commands.

5. The Adjustable Ballast-Buoyant Stabilizer System (ABBSS) controlled by Artificial Intelligence of claim 1, wherein the UABB LABB structures are divided by sections, and each section is capable to extend away from the center of the said UABB LABB Structures for the purpose of adding stability control and prevent excessive tower listing (inclination) of the floating wind turbine tower via the control of hydrodynamic forces, and wherein each section extent away from the center of the UABB LABB structures via and electro-hydraulic actuators, gears, fasteners, electric motors, and a rack railway system.

6. The Adjustable Ballast-Buoyant Stabilizer System (ABBSS) controlled by Artificial Intelligence of claim 1, wherein the ABBSS' Spherical Bearing System is comprised of a joint bearing system to handle radial and axial loads and permit a 360° rotation of the Adjustable Ballast-Buoyant Structures (ABBS) around the outside surface of the spar floater structure and wherein the said Spherical Bearing System is operating through electro-hydraulic actuators, electric motors, a rack railway system (pinion driven) circulating horizontally around the outside diameter of the spar floater structure, a gear system, and AI computer system to process the required electronic commands for the purpose of executing the required functioning of the electro-mechanical components of the said Spherical Bearing System.

7. The Adjustable Ballast-Buoyant Stabilizer System (ABBSS) controlled by Artificial Intelligence of claim 1, wherein the ABBSS' Rack Railway System (Pinion Driven) is comprised of Rack Railway System (Pinion Driven) via wheels, gears, fasteners, electric motors, and Electro-Hydraulic Actuators to provide the said Adjustable Ballast-Buoyant Stabilizer System with the capability to support and travel up and down along the length of the Floating Wind Turbine Spar-Type Towers.

8. The Adjustable Ballast-Buoyant Stabilizer System (ABBSS) controlled by Artificial Intelligence of claim 1, wherein the ABBSS' Computer System has a dedicated Neural Processing Unit (NPU) designed to run Artificial Intelligence and run a software designed to manage the required electronic commands required by the Adjustable Ballast-Buoyant Stabilizer System.

9. The Adjustable Ballast-Buoyant Stabilizer System (ABBSS) controlled by Artificial Intelligence of claim 1, wherein the ABBSS' Gyroscope System controlled by a Micro-Electro-Mechanical System (MEMS) to minimize or eliminate the listing of Floating Wind Turbine Spar-Type Towers.

10. The Adjustable Ballast-Buoyant Stabilizer System (ABBSS) controlled by Artificial Intelligence of claim 1, wherein the ABBSS' Engine Pylon is angle adjustable via multi-axis hinges operated by Electro-Hydraulic Actuators controlled by the said computer system.

11. The Adjustable Ballast-Buoyant Stabilizer System (ABBSS) controlled by Artificial Intelligence of claim 1, wherein the ABBSS' Vertical to Horizontal Auto Positioning System provides a computer-controlled vertical to horizontal positioning process to change the orientation of a Floating Wind Turbine Spar-Type Tower from a vertical position to a horizontal position through angular changes of the ABB Structures and ABB Stabilizers via Electro-Hydraulic Actuators, and changes in the ballast and buoyancy of the said ABB Structures, ABB Stabilizers, and the Floating Wind Turbine Spar-Type Tower are attained through electric fluid pumps adding or reducing liquid fluid to the said ABB Structures, ABB Stabilizers, and Floating Wind Turbine Spar-Type Tower.

12. The Adjustable Ballast-Buoyant Stabilizer System (ABBSS) controlled by Artificial Intelligence of claim 1, wherein the ABBSS' Adjustable Anchor Support Arm System vertically re-position up-down anchor support arms to control the center of gravity of the said Floating Wind Turbine Spar Type Tower to assist in the vertical control of the said Floating Wind Turbine Spar Type Tower via the Rack Railway System (Pinion Driven) and Electro-Hydraulic Actuators.
